(19) United States
(12) Patent Application Publication
(10) Pub. No.: US 2024/0147553 A1
(43) Pub. Date: May 2, 2024

(54) METHOD AND APPARATUS FOR SUBSCRIPTION OF UPF EVENT EXPOSURE SERVICE BASED ON UP

(71) Applicant: Samsung Electronics Co., Ltd., Gyeonggi-do (KR)

(72) Inventors: Kisuk KWEON, Gyeonggi-do (KR); Naman GUPTA, Gyeonggi-do (KR); Sangsoo JEONG, Gyeonggi-do (KR)

(21) Appl. No.: 18/500,606

(22) Filed: Nov. 2, 2023

(30) Foreign Application Priority Data
Nov. 2, 2022 (KR) 10-2022-0144344

(51) Int. Cl. H04W 76/12

(52) U.S. Cl. CPC H04W 76/12; H04W 80/10

(57) ABSTRACT

The disclosure relates to a 5th generation (5G) communication system or a 6th generation (6G) communication system for supporting higher data transmission rates. A method is provided for a user plane function (UPF) in a wireless communication system. The method includes receiving, from a network function (NF), a first UPF control message protocol (UCMP) message requesting a service, wherein the first UCMP protocol message is generated by the NF; performing the service based on the first UCMP protocol message; generating a second UCMP protocol message including a result of the performed service; and transmitting, to the NF, the second UCMP protocol message

### CROSS-REFERENCE TO RELATED APPLICATION

This application claims priority to and the benefit of Korean Patent Application No. 10-2022-0144344, which was filed in the Korean Intellectual Property Office on Nov. 2, 2022, the entire contents of which are incorporated herein by reference.

### BACKGROUND

### 1. Field

The disclosure relates generally to a communication system, and more particularly, to an apparatus and method for subscribing to user plane function (UPF) services based on a user plane (UP) in order to receive services provided by UPFs.

### 2. Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

As various services can be provided in accordance with the above and the development of mobile communication systems, there is a need for methods to efficiently use a non-public network (NPN) in particular.

### SUMMARY

The disclosure has been made to address at least the above-mentioned problems and/or disadvantages and to provide at least the advantages described below.

An aspect of the disclosure is to provide a method and apparatus that can effectively provide services in a wireless communication system.

Another aspect of the disclosure is to provide a method in which a network device or function subscribes to a UPF service based on a UP in order to use the service provided by the UPF.

In accordance with an aspect of the disclosure, a method is provided for a UPF in a wireless communication system. The method includes receiving, from a network function (NF), a first UPF control message protocol (UCMP) message requesting a service, wherein the first UCMP protocol message is generated by the NF; performing the service based on the first UCMP protocol message; generating a second UCMP protocol message including a result of the performed service; and transmitting, to the NF, the second UCMP protocol message.

In accordance with another aspect of the disclosure, a method is provided for an NF in a wireless communication system. The method includes generating a first UCMP protocol message requesting a service; transmitting, to an UPF, the first UCMP protocol message requesting the service; and receiving, from the NF, a second UCMP protocol message including a performance result of the service, wherein the service is performed based on the first UCMP protocol message, and wherein the second UCMP protocol message is generated by the UPF.

In accordance with another aspect of the disclosure, a UPF is provided for use in a wireless communication system. The UPF includes a transceiver; and a processor operably connected to the transceiver, wherein the processor is configured to receive, from an NF, a first UCMP protocol message requesting a service, wherein the first UCMP protocol message is generated by the NF, perform the service based on the first UCMP protocol message, generate a second UCMP protocol message including a result of the performed service, and transmit, to the NF, the second UCMP protocol message.

In accordance with another aspect of the disclosure, an NF is provided for use in a wireless communication system. The NF includes a transceiver; and a processor operably connected to the transceiver, wherein the processor is configured to generate a first UCMP protocol message requesting a service, transmit, to a UPF, the first UCMP protocol message requesting the service, and receive, from the NF, a second UCMP protocol message including a performance result of the service, wherein the service is performed based on the first UCMP protocol message, and wherein the second UCMP protocol message is generated by the UPF.

### BRIEF DESCRIPTION OF THE DRAWINGS

The above and other aspects, features, and advantages of certain embodiments of the disclosure will become more apparent from the following description with reference to the accompanying drawings, in which:

FIG. 1 illustrates a 5G network according to an embodiment;

FIG. 2 illustrates a transmission control protocol/Internet protocol (TCP/IP) protocol stack and a datagram header (packet header) of an IP layer;

FIG. 3 illustrates an IP layer including a UCMP according to an embodiment;

FIG. 4 illustrates an IP datagram including a UCMP protocol message and a UCMP protocol message format according to an embodiment.

FIG. 5 illustrates an operation of a UCMP protocol according to an embodiment;

FIG. 6 is a signal flow diagram illustrating an NF procedure for requesting a UPF service subscription according to an embodiment;

FIG. 7 is a signal flow diagram illustrating an NF procedure for withdrawing a UPF service subscription request according to an embodiment;

FIG. 8 is a signal flow diagram illustrating a result reporting procedure by a UPF for a service subscribed to by an NF according to an embodiment;

FIG. 9 illustrates a UE according to an embodiment; and

FIG. 10 illustrates an network entity (NE) according to an embodiment.

### DETAILED DESCRIPTION

Hereinafter, various embodiments of the disclosure are described in detail with reference to the accompanying drawings. The same or similar reference numbers may refer to the same elements in the accompanying drawings. Furthermore, a detailed description of known functions or constructions that may make the subject matter of the disclosure vague will be omitted.

Herein, in describing the embodiments, descriptions of technology contents that are well known in the art to which the disclosure pertains and that are not directly related to the disclosure are omitted to avoid obscuring the subject matter of the disclosure with unnecessary description.

In the accompanying drawings, some elements may be enlarged, omitted, or schematically depicted. Furthermore, the size of each element does not accurately reflect its real size.

Advantages and characteristics of the disclosure and a method for achieving the advantages and characteristics will become apparent from the embodiments described in detail in conjunction with the accompanying drawings. However, the disclosure is not limited to the disclosed embodiments, but may be implemented in various different forms. The embodiments are provided to only complete the disclosure and to fully notify a person having ordinary knowledge in the art to which the disclosure pertains of the category of the disclosure. The disclosure is defined by the category of the claims.

Herein, each block of the flowchart illustrations and combinations of the blocks in the flowchart illustrations can be executed by computer program instructions. These computer program instructions may be mounted on the processor of a general purpose computer, a special purpose computer, or other programmable data processing equipment, so that the instructions executed by the processor of the computer or other programmable data processing equipment create means for executing the functions specified in the flowchart block(s).

These computer program instructions may also be stored in a computer-usable or computer-readable memory that can direct a computer or other programmable data processing equipment to implement a function in a particular manner, such that the instructions stored in the computer-usable or computer-readable memory produce an article of manufacture including instruction means that implement the function specified in the flowchart block(s). The computer program instructions may also be loaded on a computer or other programmable data processing equipment to cause a series of operational steps to be performed on the computer or other programmable data processing equipment to produce a computer-executed process, so that the instructions performing the computer or other programmable data processing equipment provide steps for executing the functions described in the flowchart block(s).

Each block of the flowchart illustrations may represent a portion of a module, a segment, or code, which includes one or more executable instructions for implementing a specified logical function(s). In some alternative implementations, the functions noted in the blocks may occur out of order. For example, two blocks shown in succession may in fact be executed substantially concurrently, or the blocks may sometimes be executed in the reverse order, depending upon the functionality involved.

Herein, the term “unit” may refer to software or a hardware component, such as a field programmable gate array (FPGA) or an application specific integrated circuit (ASIC), and the “unit” performs specific tasks. However, a “unit” is not limited to software or hardware. A “unit” may be constituted to reside on an addressable storage medium and constituted to operate on one or more processors. Accordingly, a “unit” may include, e.g., components, such as software components, object-oriented software components, class components, and task components, processes, functions, attributes, procedures, sub-routines, segments of program code, drivers, firmware, microcode, circuitry, data, databases, data structures, tables, arrays, and variables. The functionalities provided in the components and “units” may be combined into fewer components and “units” or may be further separated into additional components and “units”. Furthermore, the components and “units” may be implemented to operate on one or more central processing units (CPUs) within a device or a security multimedia card.

Herein, a base station (BS) is described as assigning resources to a terminal, and may include a Node B, an eNode B (eNB), a gNode B (gNB), a wireless access unit, a BS controller (BSC), and a node in a network. The terminal may include a UE, a mobile station (MS), a cellular phone, a smartphone, a computer, or a multimedia system capable of performing a communication function.

Furthermore, embodiments of the disclosure may also be applied to other communication systems having similar technical backgrounds or channel forms as those hereinafter described. Additionally, embodiments of the disclosure may also be applied to other communication systems through some modifications in a range based on a decision of a person having skilled technical knowledge.

Herein, terms for identifying an access node (AN), terms to denote NEs or NFs, terms to denote messages, terms to denote an interface between NEs, terms to denote various types of identification information, etc., which are used in the following description, have been exemplified for convenience of description. Accordingly, the disclosure is not limited to the exact terms used herein, and another term to denote a target having an equivalent technical meaning may be used.

Hereinafter, for convenience of description, some of terms and names defined in the 3rd generation partnership project (3GPP) long term evolution (LTE) standard may be used. However, the disclosure is not restricted by the terms and names, and may also be identically applied to systems that follow other standards.

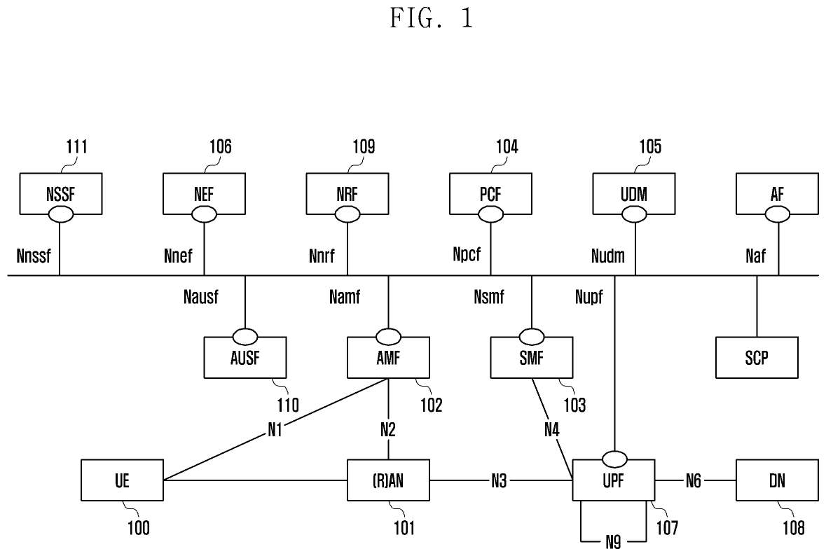

FIG. 1 illustrates a 5G network according to an embodiment.

Referring to FIG. 1, a (radio) access network ((R)AN)) 101 assigns a radio resource to a terminal, and may include at least one of an eNode B, a Node B, a BS, a NextGeneration radio access network (NG-RAN), a 5G-AN, a wireless access unit, a BSC, and a node in a network. The terminal 100 may include a UE, a NextGeneration (NG) UE, an MS, a cellular phone, a smartphone, a computer, or a multimedia system capable of performing a communication function.

Although embodiments of the disclosure are described with reference to a 5G system, embodiments of the disclosure may also be applied to other communication system having a similar technical background.

As the 4G system evolves into the 5G system, a wireless communication system defines an NG core, i.e., a new core network, or a 5G core network (5GC). The new core network has produced all the existing NEs as an NF by virtualizing the NEs. Herein, the NF may refer to an NE, a network component, or a network resource.

The 5GC may include NFs illustrated in FIG. 1. The disclosure is not limited to the example of FIG. 1, and the 5GC may include a larger number or smaller number of NFs than the NFs illustrated in FIG. 1.

An access and mobility management function (AMF) 102 may be an NF for managing mobility of the UE 100.

A session management function (SMF) 103 may be an NF for managing a packet data network (PDN) connection that is provided to the UE 100. The PDN connection may be denoted as the name of a protocol data unit (PDU) session.

A policy control function (PCF) 104 may be an NF that applies, to the UE 100, a service policy, billing policy, and policy for a PDU Session, of a mobile communication operator.

A unified data management (UDM) 105 may be an NF that stores information on a subscriber.

A network exposure function (NEF) 106 may be an NF that provides information about the UE 100 to a server outside of a 5G network. Furthermore, the NEF 106 may provide a function for storing, in a unified data repository (UDR), information for a service in a 5G network by providing the information.

A UPF 107 may be an NF for performing the role of a gateway that transfers user data (e.g., PDUs) to a data network (DN) 108.

A network repository function (NRF) 109 may perform a function for discovering an NF.

An authentication server function (AUSF) 110 may perform UE authentication in a 3GPP access network and a non-3GPP access network.

A network slice selection function (NSSF) 111 may perform a function for selecting a network slice instance provided to the UE 100.

The UE 100 transmits and receives data to and from the DN 108 in order to use a service of a network operator or a 3rd party service.

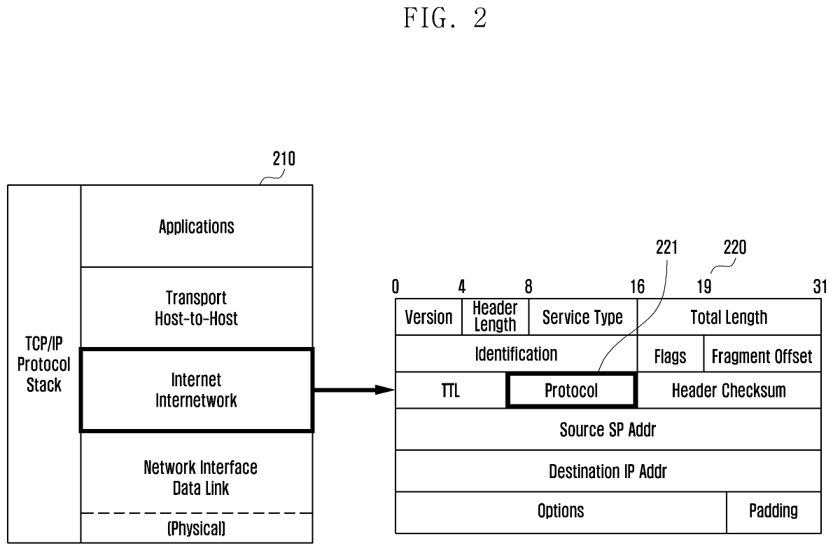

FIG. 2 illustrates a TCP/IP protocol stack 210 and a datagram header 220 of an IP Layer.

Referring to FIG. 2, an IP datagram header 220 has a protocol field 221. In IPv6 standard, there is a next header. The disclosure is described based on the IPv4 protocol, but the disclosure is equally applied to the IPv6 protocol.

The protocol field 221 (Next header field according to IPv6 standard) is an 8-bit field, which defines a higher layer protocol that uses IP layer services. The IP datagram may encapsulate several types of higher layer protocols such as a TCP, a user datagram protocol (UDP), an Internet control message protocol (ICMP), and an Internet group management protocol (IGMP).

TABLE 1
Table 1 List of IP protocol numbers

| | Protocol | | |
|---|---|---|---|
| Hex | Number | Keyword | Protocol |
| 0x00 | 0 | HOPOPT | IPv6 Hop-by-Hop Option |
| 0x01 | 1 | ICMP | Internet Control Message Protocol |
| 0x02 | 2 | IGMP | Internet Group Management Protocol |
| 0x03 | 3 | GGP | Gateway-to-Gateway Protocol |
| 0x04 | 4 | IP-in-IP | IP in IP (encapsulation) |
| 0x05 | 5 | ST | Internet Stream Protocol |
| 0x06 | 6 | TCP | Transmission Control Protocol |
| 0x07 | 7 | CBT | Core-based trees |
| 0x08 | 8 | EGP | Exterior Gateway Protocol |
| . | . | . | . |
| . | . | . | . |
| . | . | . | . |
| 0x8F | 143 | Ethernet | |
| 0x90- | 144-252 | Unassigned | |
| 0xFC | | | |
| 0xFD- | 253-254 | Use for experimentation and testing | |
| 0xFE | | | |
| 0xFF | 255 | Reserved | |

Table 1 above shows a list of values that may be entered in the protocol field 221, i.e., a list of higher protocols that may be encapsulated by the IP datagram. To date, 143 protocols have been defined.

In accordance with an embodiment of the disclosure a new higher level protocol is provided, which may be encapsulated by the IP datagram. Through the new protocol, NFs may use the services provided by a UPF through a UP.

TABLE 2
Table 2 List of IP protocol numbers with UCMP

| | Protocol | | |
|---|---|---|---|
| Hex | Number | Keyword | Protocol |
| 0x00 | 0 | HOPOPT | IPv6 Hop-by-Hop Option |
| 0x01 | 1 | ICMP | Internet Control Message Protocol |
| 0x02 | 2 | IGMP | Internet Group Management Protocol |
| . | . | . | . |
| . | . | . | . |
| . | . | . | . |
| 0x8F | 143 | Ethernet | |
| 0x90 | 144 | UCMP | UPF Control Message Protocol |
| 0x91- | 145-252 | Unassigned | |
| 0xFC | | | |
| 0xFD- | 253-254 | Use for experimentation and testing | |
| 0xFE | | | |
| 0xFF | 255 | Reserved | |

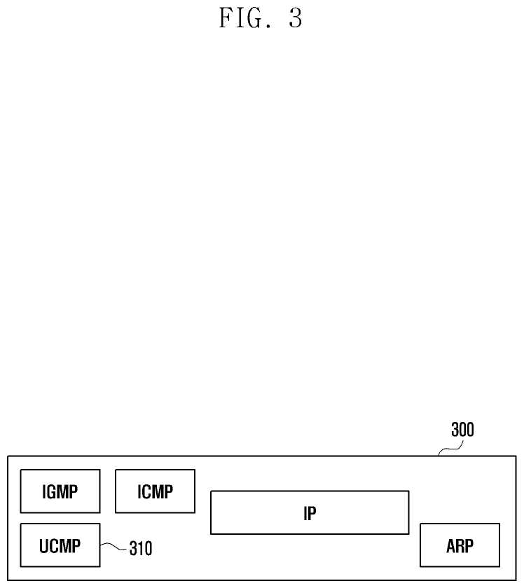

FIG. 3 illustrates an IP layer including a UCMP according to an embodiment.

Referring to FIG. 3, the UCMP 310 is included in an IP layer 300 like the IGMP, the ICMP, and an address resolution protocol (ARP) protocol.

Table 2 shows a list of IP protocol numbers including the new protocol UPF control message protocol (i.e., UCMP 310). UCMP 310 assigned number 144, which is still unused. The new protocol name and IP protocol number may be changed.

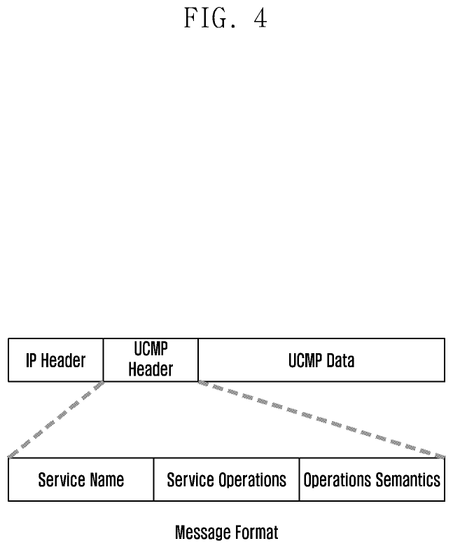

FIG. 4 illustrates an IP datagram including a UCMP protocol message and a UCMP protocol message format according to an embodiment.

Referring to FIG. 4, the value of the protocol field of the IP header is entered as 144, indicating the UCMP protocol. The UPF service name, service operation, and operation semantic values are entered into the UCMP header. UCMP Data includes parameter values required for UPF service.

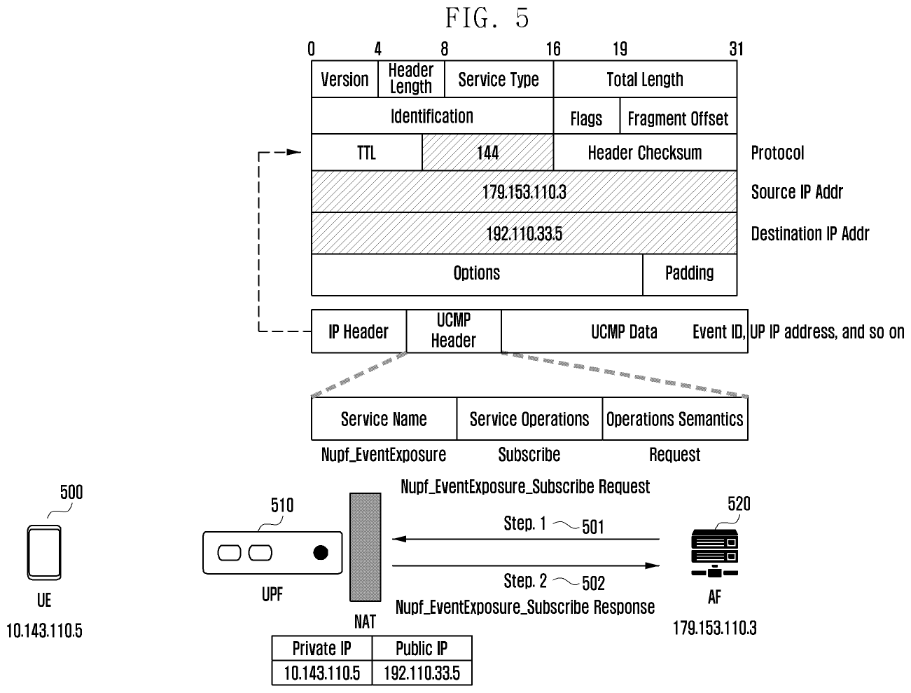

FIG. 5 illustrates an operation of a UCMP according to an embodiment.

Referring to FIG. 5, a UE 500 is assigned a PDU session having private IP address, 10.143.110.5, by a UPF 510. The UE 500 receives certain services from an external server, i.e., application function (AF) 520, through the PDU session. The AF 520 provides services to the UE 500 using a public IP address, 179.153.110.3. Telecommunications carriers use a network address translation (NAT) device to change the private IP address assigned to the UE 500 to a public IP address that can be used in the public network and transmit the public IP address to an external network. In FIG. 5, the UE's private IP address, 10.143.110.5, is changed to the public IP address, 192.110.33.5. That is, the AF 520, which is outside of the telecommunications carrier network, knows that the UE's IP address is 192.110.33.5, which has been changed by the NAT.

The AF 520 requests subscription to the UPF service in order to use specific UPF services. To request the subscription, the AF 520 generates a UCMP protocol message, includes the UCMP protocol message in the IP datagram, and sends the message in step 501. The value ‘144’ is entered in the protocol field of the IP header to indicate that the IP datagram includes the UCMP protocol message. In a source IP address field, the AF's IP address, ‘179.153.110.3’, is entered. Ina destination address field, the value ‘192.110.33.5’, which is the public IP address of the UE 500, is entered.

The following values are entered into the UCMP header.

The UPF service name ‘Nupf_EventExposure’ is entered in the Service Name field. The value ‘Subscribe’, which is a service subscription, is entered in the Service Operations field. The value ‘Request’, which is a service request, is entered in the Operation Semantics field. The UCMP Data field includes parameter values required for the service subscription request. The parameter values may vary, such as Event ID, UE's IP address, generic public subscription identifier (GPSI), data network name (DNN), and single network slice selection assistance information (S-NSSAI).

The corresponding IP datagram is transmitted to a PDU session anchor (PSA) UPF 510, the UE's home router. The UPF 510 processes the header of the IP datagram. In this case, since the value of the Protocol field is ‘144’, it is known that the IP datagram includes the UCMP protocol message. In other words, the IP datagram does not include user data transmitted to the UE 500, but includes the UCMP protocol message requesting service from the UPF serving the corresponding UE 500. The UPF 510 reads the UCMP protocol messages and processes the requested service subscription. The corresponding IP datagram is discarded rather than transmitted to the UE 500.

In step 502, the UPF 510 transmits the result of requested service subscription processing to the AF 520. To do this, the UCMP protocol message is generated.

The following values are entered into the UCMP header.

The UPF service name ‘Nupf_EventExposure’ is entered in the Service Name field. The value ‘Subscribe’, which is the service subscription, is entered in the Service Operations field. The value ‘Response’, which is a response to the service request, is entered in the Operation Semantics field. The UCMP Data field includes the parameter values required to respond to the service subscription request.

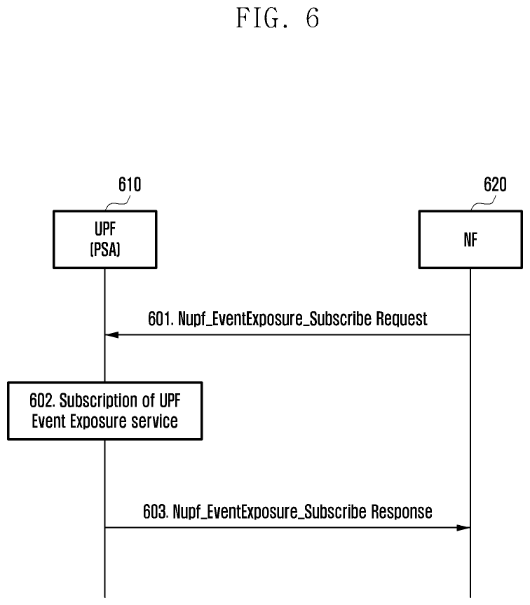

FIG. 6 is a signal flow diagram illustrating an NF procedure for requesting a UPF service subscription according to an embodiment. Specifically, FIG. 6 illustrates, as an example, an EventExposure service among UPF services. However, other UPF service subscription request procedures also perform the same procedure, with only the Service Name, Service Operations, and Operation Semantics values being different.

Referring to FIG. 6, in step 601, the NF 620 generates a UCMP protocol message to subscribe to UPF's EventExposure service.

The following values are entered into the UCMP header.

The value ‘Nupf_EventExposure’, which is an UPF service name, is entered in the Service Name field. The value ‘Subscribe’, which is a service subscription, is entered in the Service Operations field. The value ‘Request’, which is a service subscription request, is entered in the Operation Semantics field. The UCMP Data field includes parameter values required for the service subscription request. The parameter values vary, such as Event ID, UE's IP address, GPSI, DNN, and S-NSSAI.

In step 602, the UPF 610 processes the header of the IP datagram. Since the value of the Protocol field is ‘144’, it is known that the IP datagram includes the UCMP protocol message. In other words, the corresponding IP datagram does not include user data transmitted to the UE, but includes the UCMP protocol message requesting service from the UPF serving the UE. The UPF 610 reads the UCMP protocol messages and processes the requested service subscription. The corresponding IP datagram is discarded rather than transmitted to the UE.

In step 603, the UPF 610 transmits the result of requested service subscription processing to the NF 620. To do this, the UCMP protocol message is generated.

The following values are entered into the UCMP header. The value ‘Nupf_EventExposure’, which is the UPF service name, is entered in the Service Name field. The value ‘Subscribe’, which is a service subscription, is entered in the Service Operations field. The value ‘Response’, which is a response to the service request, is entered in the Operation Semantics field. The UCMP Data field includes parameter values required to respond to the corresponding service subscription request.

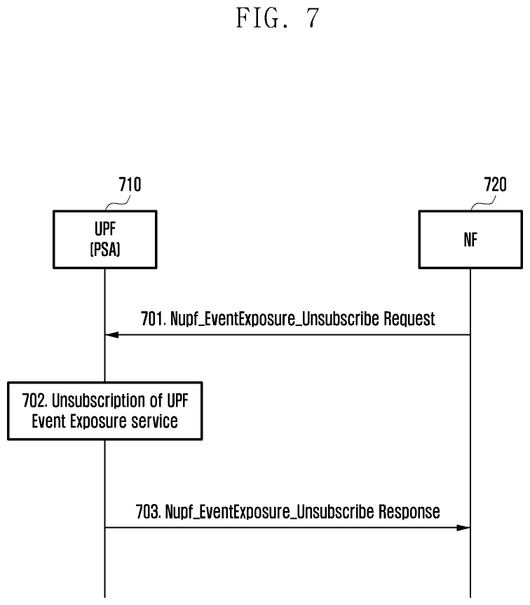

FIG. 7 is a signal flow diagram illustrating an NF procedure to withdraw a UPF service subscription request according to an embodiment. Specifically, FIG. 7 illustrates, as an example, an EventExposure service among UPF services. However, other procedures for withdrawing the UPF service subscription request are the same, with only the Service Name, Service Operations, and Operation Semantics values being different.

Referring to FIG. 7, in step 701, the NF 720 generates a UCMP protocol message to withdraw the previously subscribed UPF's EventExposure service subscription.

The following values are entered into the UCMP header.

The value ‘Nupf_EventExposure’, which is the UPF service name, is entered in the Service Name field. The value ‘Unsubscribe’, which is withdrawal of the service subscription, is entered in the Service Operations field. The value ‘Request’, which is a request to withdraw the service subscription, is entered in the Operation Semantics field. The UCMP Data field includes parameter values required to request the withdrawal of subscription to the service. The parameter values may vary, such as subscription correlation ID, Event ID, UE's IP address, GPSI, DNN, and S-NSSAI.

In step 702, the UPF 710 processes the header of the IP datagram. Since the value of the Protocol field is ‘144’, it is known that the IP datagram includes the UCMP protocol message. In other words, the corresponding IP datagram does not include user data transmitted to the UE, but includes the UCMP protocol message requesting service from the UPF serving the UE. The UPF 710 reads the UCMP protocol message and processes the requested service subscription withdrawal. The corresponding IP datagram is discarded rather than transmitted to the UE.

In step 703, the UPF 710 transmits the result of requested service subscription withdrawal processing to the NF. To do this, the UCMP protocol message is generated.

The following values are entered into the UCMP header.

The value ‘Nupf_EventExposure’, which is the UPF service name, is entered in the Service Name field. The value ‘Unsubscribe’, which is withdrawal of service subscription, is entered in the Service Operations field. The value ‘Response’, which is a response to the service request, is entered in the Operation Semantics field. The UCMP Data field includes parameter values required to respond to the request to withdraw the corresponding service subscription.

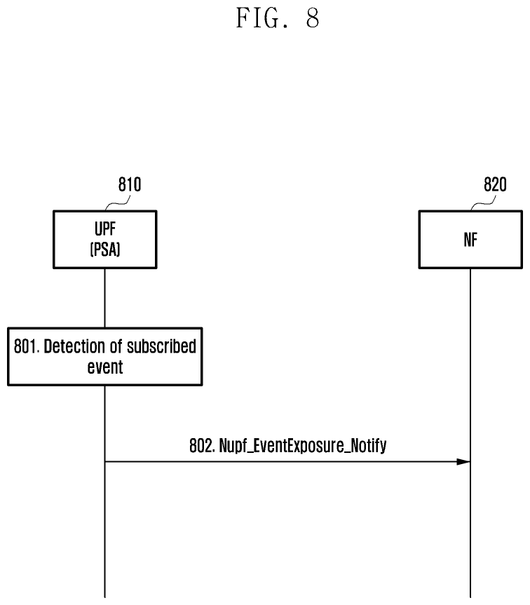

FIG. 8 is a signal flow diagram illustrating a result reporting procedure by a UPF for a service subscribed to by an NF according to an embodiment. Specifically, FIG. 8 illustrates, as an example, an EventExposure service among UPF services. However, other procedures for withdrawing the UPF service subscription request are the same, with only the Service Name, Service Operations, and Operation Semantics values being different.

Referring to FIG. 8, when an event occurs for the UPF service to which the NF 820 subscribed in step 801, the UPF 810 detects the event occurrence.

In step 802, the UPF 810 transmits a report on the detected event to the NF 820. To do this, a UCMP protocol message is generated.

The following values are entered into the UCMP header.

The value ‘Nupf_EventExposure’, which is the UPF service name, is entered in the Service Name field. The value ‘Notify’, which is a service report notification, is entered in the Service Operations field. The value ‘Notify’, which is a service report notification, is entered in the Operation Semantics field. The UCMP Data field includes parameter values required for reporting the corresponding service.

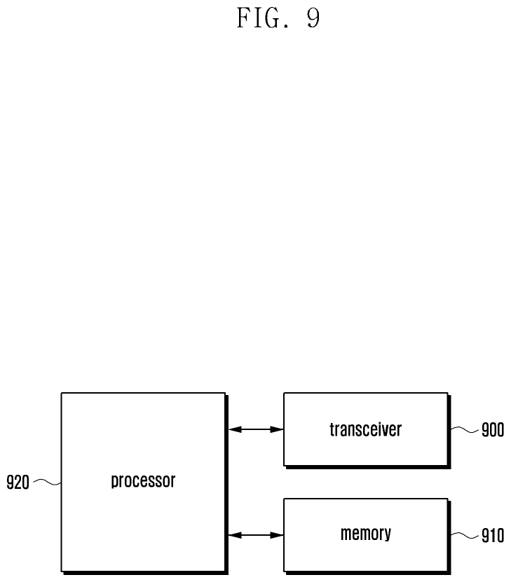

FIG. 9 illustrates a UE according to an embodiment.

Referring to FIG. 9, a UE includes a processor 920 that controls an overall operation of the UE, a transceiver 900 that includes a transmitter and a receiver, and a memory 910. The UE is not limited the above illustration, and the UE may include elements more or fewer than those illustrated in FIG. 9.

The transceiver 900 may transmit/receive a signal to/from an NE or another terminal. The signal transmitted/received to/from the NE may include control information and data. Also, the transceiver 900 may receive a signal through a wireless channel and may output a signal to the processor 920, and may transmit a signal output from the processor 920 through the wireless channel.

The processor 920 may control the UE to perform one of the above embodiments.

The processor 920, the memory 910, and the transceiver 900 are not necessarily implemented as modules, and may be implemented as one element such as a single chip. The processor 920 and the transceiver 900 may be electrically connected. Also, the processor 920 may be an application processor (AP), a communication processor (CP), a circuit, an application-specific circuit, or at least one processor.

The memory 910 may store a basic program for operating the UE, an application program, and data such as configuration information. In particular, the memory 910 provides stored data according to a request of the processor 920. The memory 910 may include a storage medium such as a read-only memory (ROM), a random-access memory (RAM), a hard disc, a compact disc (CD)-ROM, a digital versatile disc (DVD), or a combination thereof. Also, a plurality of the memories 910 may be provided. Also, the processor 920 may perform the above described embodiments based on a program for performing the embodiments of the disclosure stored in the memory 910.

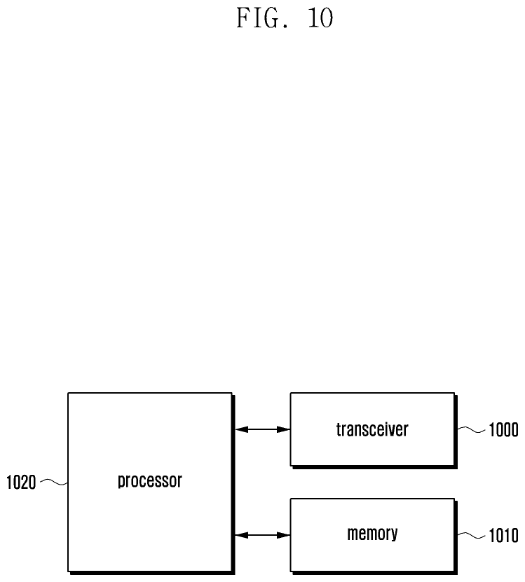

FIG. 10 illustrates an NE according to an embodiment.

Referring to FIG. 10 the NE includes a processor 1020 that controls an overall operation of the NE, a transceiver 1000 that includes a transmitter and a receiver, and a memory 1010. The NE is not limited the above illustration, and the NE may include elements more or fewer than those illustrated in FIG. 10.

The transceiver 1000 may transmit/receive a signal to/from at least one of other NEs or a UE. The signal transmitted/received to/from at least one of the other NEs and the UE may include control information and data.

The processor 1020 may control the NE to perform one of the above embodiments of the disclosure. The processor 1020, the memory 1010, and the transceiver 1000 are not necessarily implemented as separate modules and may be implemented as one element such as a single chip. The processor 1020 and the transceiver 1000 may be electrically connected. Also, the processor 1020 may be an AP, a CP, a circuit, an application-specific circuit, or at least one processor.

The memory 1010 may store a basic program for operating the NE, an application program, and data such as configuration information. In particular, the memory 1010 provides stored data according to a request of the processor 1020. The memory 1010 may include a storage medium such as a ROM, a RAM, a hard disc, a CD-ROM, or a DVD, or a combination thereof. Also, a plurality of the memories 1010 may be provided. Also, the processor 1020 may perform the above described embodiments based on a program for performing the embodiments of the disclosure stored in the memory 1010.

It will be understood that a diagram illustrating a constitution, a diagram illustrating a method of transmitting a control/data signal, a diagram illustrating an operation procedure, and a diagram illustrating constitutions in the above are not intended to limit the scope of the disclosure. That is, all of elements, entities, or steps of operations described in embodiments of the disclosure should not be construed as essential elements for carrying out the disclosure, and the disclosure may be carried out only with some elements without departing from the scope of the disclosure. Also, the embodiments of the disclosure may be performed in combination as needed. For example, some of methods provided by the disclosure may be combined to operate an NE and a UE.

Operations of a BS or a UE in the above may be performed by providing a memory device storing corresponding program code in any element of the BS or UE apparatus. That is, a controller of the BS or UE apparatus may perform the operations by reading and executing the program code stored in the memory device, e.g., through a processor or a CPU.

As described herein, various elements or modules in an entity, a BS, or a UE in the above may operate by using a hardware circuit, e.g., a complementary metal oxide semiconductor-based logic circuit, firmware, software, and/or a hardware circuit such as a combination of hardware, firmware, and/or software embedded in a machine-readable medium. For example, various electrical structures and methods may be carried out by using electrical circuits such as transistors, logic gates, and application specific integrated circuits.

When a method is implemented by software, a computer-readable storage medium for storing one or more programs (software modules) may be provided. The one or more programs stored in the computer-readable storage medium are configured to be executed by one or more processors in an electronic device. The one or more programs include instructions for allowing the electronic device to perform methods according to the claims of the disclosure or embodiments of the disclosure described in the specification of the disclosure.

Such programs (software modules and software) may be stored in a RAM, a non-volatile memory including a flash memory, a ROM, an electrically erasable programmable ROM (EEPROM), a magnetic disc storage device, a CD-ROM, a DVD, another optical storage device, or a magnetic cassette. Alternatively, the programs may be stored in a memory constituted by combining some or all of them. Also, the constituted memory may include a plurality of memories.

Also, the programs may be stored in an attachable storage device accessible through a communication network such as the Internet, an intranet, a local area network (LAN), a wide LAN (WLAN), or a storage area network (SAN), or a combination thereof. This storage device may access a device for performing embodiments of the disclosure through an external port. Also, a separate storage device on a communication network may access a device for performing embodiments of the disclosure.

In specific embodiments of the disclosure described above, elements included in the disclosure were expressed singular or plural in accordance with the specific embodiments of the disclosure. However, singular or plural representations are selected appropriately for the sake of convenience of explanation, the disclosure is not limited to singular or plural constituent elements, and even expressed as a singular element, it may be constituted with plural elements, and vice versa.

While the particular embodiments of the disclosure have been particularly described, it will be apparent that various changes in form and details may be made therein without departing from the scope of the disclosure. Hence, the scope of the disclosure is not defined by the embodiments of the disclosure but by the claims and equivalents thereof fall within the scope of the disclosure. That is, it will be obvious to one of ordinary skill in the art that various modifications may be made based on the technical scope of the disclosure. Also, each of the above embodiments may be operated in combination with each other as needed. For example, some of methods provided by the disclosure may be combined with each other to operate a BS and a UE. Also, although the embodiments of the disclosure are described based on 5G and NR systems, modifications based on the technical scope of the embodiments of the disclosure may be applied to other communication systems such as LTE, LTE advanced (LTE-A), and LTE-A-Pro systems.

While the disclosure has been particularly shown and described with reference to specific embodiments thereof, it will be apparent that various changes in form and details may be made therein without departing from the scope of the disclosure. Hence, the scope of the disclosure is not defined by the embodiments of the disclosure but by the claims and equivalents thereof fall within the scope of the disclosure.

What is claimed is:

1. A method performed by a user plane function (UPF) in a wireless communication system, the method comprising:
receiving, from a network function (NF), a first UPF control message protocol (UCMP) message requesting a service, wherein the first UCMP protocol message is generated by the NF;
performing the service based on the first UCMP protocol message;
generating a second UCMP protocol message including a result of the performed service; and
transmitting, to the NF, the second UCMP protocol message.

2. The method of claim 1, wherein each of the first UCMP protocol message and the second UCMP protocol message includes an Internet protocol (IP) header, a UCMP header, and UCMP data.

3. The method of claim 2, wherein the UCMP header includes a service name, a service operation, and an operation semantic.

4. The method of claim 2, wherein UCMP data includes at least one of:
an event identifier (ID),
a terminal IP address,
a generic public subscription identifier (GPSI),
a data network name (DNN), or
single network slice selection assistance information (S-NSSAI).

5. A method performed by a network function (NF) in a wireless communication system, the method comprising:
generating a first user plane function (UPF) control message protocol (UCMP) message requesting a service;
transmitting, to a UPF, the first UCMP protocol message requesting the service; and
receiving, from the NF, a second UCMP protocol message including a performance result of the service,
wherein the service is performed based on the first UCMP protocol message, and
wherein the second UCMP protocol message is generated by the UPF.

6. The method of claim 5, wherein each of the first UCMP protocol message and the second UCMP protocol message includes an Internet protocol (IP) header, a UCMP header, and UCMP data.

7. The method of claim 6, wherein the UCMP header includes a service name, a service operation, and an operation semantic.

8. The method of claim 6, wherein UCMP data includes at least one of:
an event identifier (ID),
a terminal IP address,
a generic public subscription identifier (GPSI),
a data network name (DNN), or
single network slice selection assistance information (S-NSSAI).

9. A user plane function (UPF) in a wireless communication system, the UPF comprising:
a transceiver; and
a processor operably connected to the transceiver, and configured to:
receive, from a network function (NF), a first UPF control message protocol (UCMP) message requesting a service, wherein the first UCMP protocol message is generated by the NF,
perform the service based on the first UCMP protocol message,
generate a second UCMP protocol message including a result of the performed service, and
transmit, to the NF, the second UCMP protocol message.

10. The UPF of claim 9, wherein each of the first UCMP protocol message and the second UCMP protocol message includes an Internet protocol (IP) header, a UCMP header, and UCMP data.

11. The UPF of claim 10, wherein the UCMP header includes a service name, a service operation, and an operation semantic.

12. The UPF of claim 10, wherein UCMP data includes at least one of:
an event identifier (ID),
a terminal IP address,
a generic public subscription identifier (GPSI),
a data network name (DNN), or
single network slice selection assistance information (S-NSSAI).

13. A network function (NF) in a wireless communication system, the NF comprising:
a transceiver; and
a processor operably connected to the transceiver, and configured to:
generate a first user plane function (UPF) control message protocol (UCMP) message requesting a service,
transmit, to a UPF, the first UCMP protocol message requesting the service, and
receive, from the NF, a second UCMP protocol message including a performance result of the service,
wherein the service is performed based on the first UCMP protocol message, and
wherein the second UCMP protocol message is generated by the UPF.

14. The NF of claim 13, wherein each of the first UCMP protocol message and the second UCMP protocol message includes an Internet protocol (IP) header, a UCMP header, and UCMP data.

15. The NF of claim 14, wherein the UCMP header includes a service name, a service operation, and an operation semantic.

16. The NF of claim 14, wherein the UCMP data includes at least one of:
an event identifier (ID),
a terminal IP address,
a generic public subscription identifier (GPSI),
a data network name (DNN), or
single network slice selection assistance information (S-NSSAI).
